(19) United States
(12) Patent Application Publication
(10) Pub. No.: US 2022/0234637 A1
(43) Pub. Date: Jul. 28, 2022

(54) STROLLER

(71) Applicant: Wonderland Switzerland AG, Steinhausen (CH)

(72) Inventors: Liwu Fang, Dongguan (CN); Zhengwen Guo, Dongguan (CN)

(73) Assignee: Wonderland Switzerland AG, Steinhausen (CH)

(21) Appl. No.: 17/579,612

(22) Filed: Jan. 20, 2022

(30) Foreign Application Priority Data
Jan. 22, 2021 (CN) 202110089889.5

(51) Int. Cl. B62B 7/06

(52) U.S. Cl. CPC B62B 7/062

(57) ABSTRACT

A stroller includes a rear leg, a restraining member, a front leg, a wheel base and a wheel. The restraining member is disposed on the rear leg. The front leg is capable of being folded with respect to the rear leg. The wheel base is pivotally connected to the front leg. The wheel is pivotally connected to the wheel base. When the front leg is folded with respect to the rear leg, the restraining member restrains the wheel from rotating, so as to prevent the wheel from deflection. Accordingly, the folded stroller can stand stably and will not topple.

### BACKGROUND OF THE INVENTION

### 1. Field of the Invention

The invention relates to a stroller and, more particularly, to a stroller capable of preventing a wheel from deflection when being folded.

### 2. Description of the Prior Art

A stroller is a tool used by parents to carry babies or children when they go shopping. At present, there are various foldable strollers to facilitate storage or transportation. The foldable stroller comprises a frame, a front leg, a rear leg, a wheel base pivotally connected to the front leg, and a wheel pivotally connected to the wheel base. In general, there is a pivot structure disposed on the frame and between the front leg and the rear leg. When the stroller is folded, the front leg can be folded with respect to the pivot structure and the rear leg, thereby reducing the volume of the stroller. However, as shown in FIG. 1, when the front leg 34 and the rear leg 30 of the conventional stroller 3 are folded, the wheel 38 pivotally connected to the wheel base 36 may deflect with respect to the rear leg 30, such that the folded stroller 3 cannot stand stably and may topple easily.

### SUMMARY OF THE INVENTION

The invention provides a stroller capable of preventing a wheel from deflection when being folded, so as to solve the aforesaid problems.

According to an embodiment of the invention, a stroller comprises a rear leg, a restraining member, a front leg, a wheelbase and a wheel. The restraining member is disposed on the rear leg. The front leg is capable of being folded with respect to the rear leg. The wheel base is pivotally connected to the front leg. The wheel is pivotally connected to the wheel base. When the front leg is folded with respect to the rear leg, the restraining member restrains the wheel from rotating.

Preferably, the restraining member comprises two restraining portions and the two restraining portions are opposite to each other, such that a restraining recess is formed between the two restraining portions. When the front leg is folded with respect to the rear leg, the wheel is engaged in the restraining recess.

Preferably, the two restraining portions extend outward to form a V-shaped structure.

Preferably, a front end of each of the two restraining portions has a protruding portion. When the front leg is folded with respect to the rear leg, the wheel is clamped between two protruding portions of the two restraining portions.

Preferably, the stroller further comprises a handle and a pivot structure. The handle is pivotally connected to the front leg by the pivot structure.

Preferably, the stroller further comprises a connecting member pivotally connected to the front leg and the rear leg.

As mentioned in the above, the invention disposes the restraining member on the rear leg. When the front leg is folded with respect to the rear leg, the restraining member can restrain the wheel from rotating, so as to prevent the wheel from deflection. Accordingly, the folded stroller can stand stably and will not topple.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side view illustrating a stroller of the prior art after being folded.

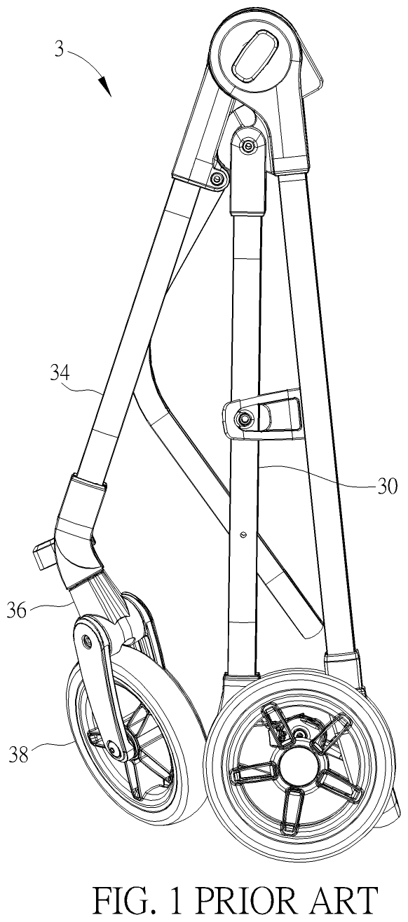

FIG. 2 is a perspective view illustrating a stroller according to an embodiment of the invention.

FIG. 3 is an enlarged view illustrating a restraining member shown in FIG. 2.

FIG. 4 is a perspective view illustrating the stroller shown in FIG. 2 after being folded.

FIG. 5 is a side view illustrating the stroller shown in FIG. 2 after being folded.

FIG. 6 is an enlarged view illustrating a restraining member according to another embodiment of the invention.

### DETAILED DESCRIPTION

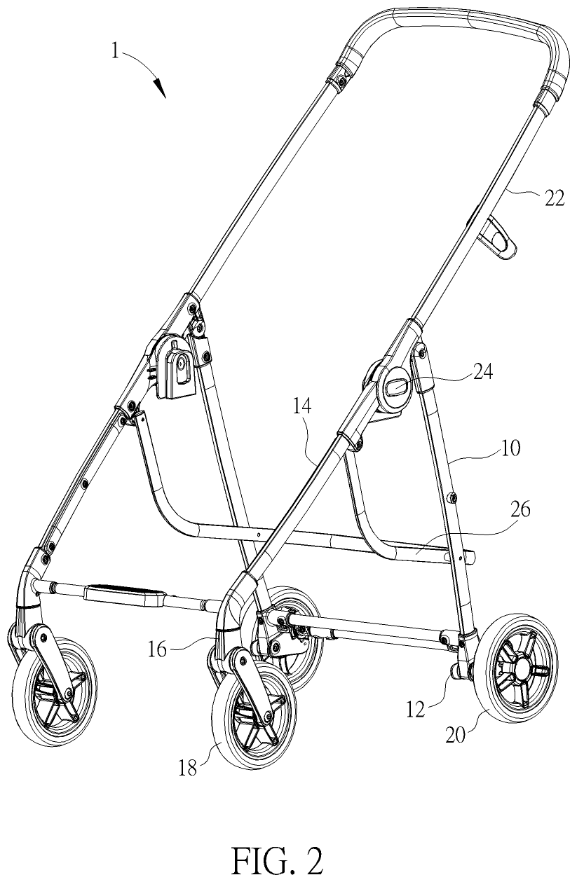

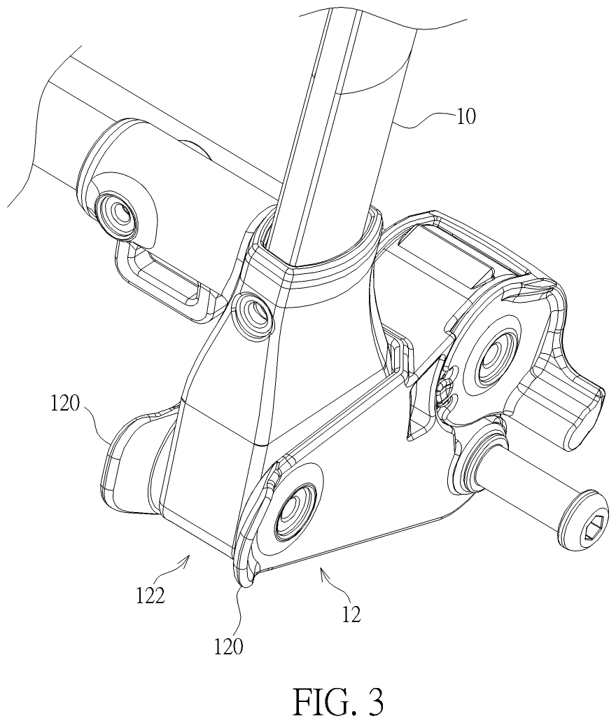

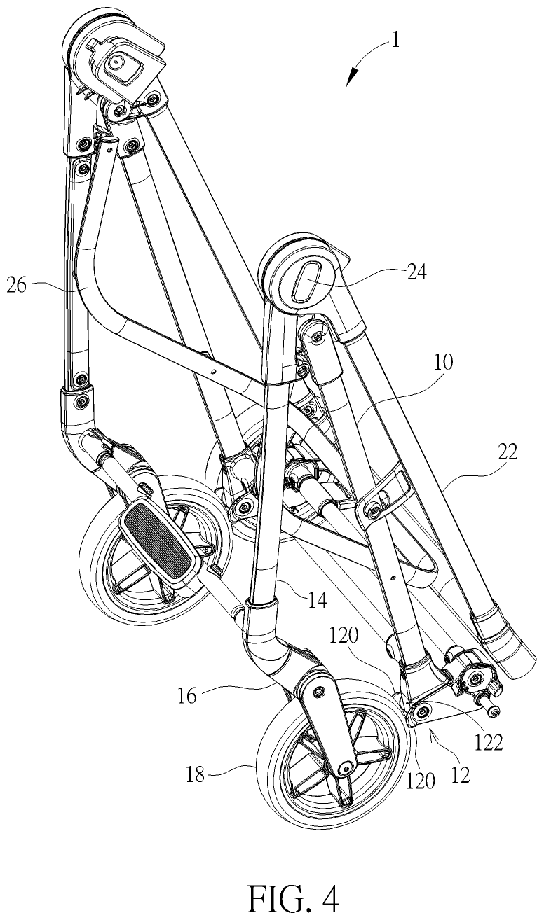

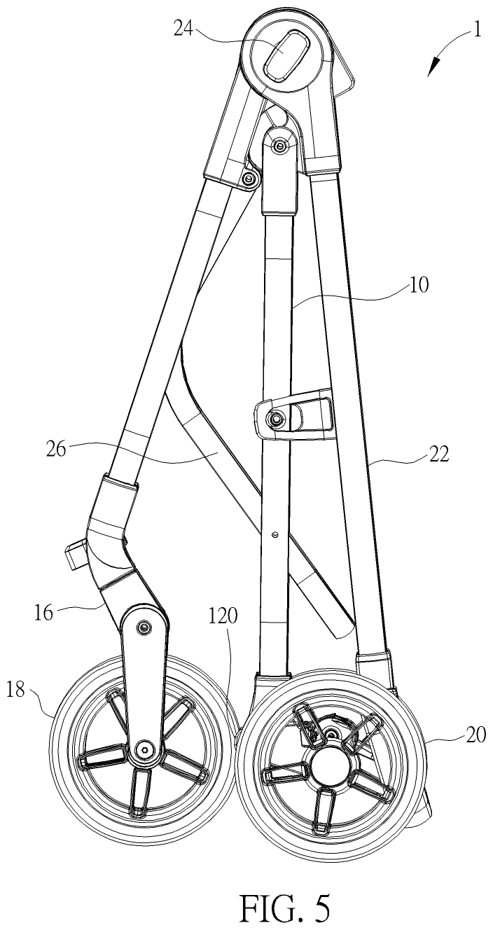

Referring to FIGS. 2 to 5, FIG. 2 is a perspective view illustrating a stroller 1 according to an embodiment of the invention, FIG. 3 is an enlarged view illustrating a restraining member 12 shown in FIG. 2, FIG. 4 is a perspective view illustrating the stroller 1 shown in FIG. 2 after being folded, and FIG. 5 is a side view illustrating the stroller 1 shown in FIG. 2 after being folded.

As shown in FIG. 2, the stroller 1 of the invention comprises a rear leg 10, a restraining member 12, a front leg 14, a wheel base 16 and a wheel 18. The restraining member 12 is disposed on the rear leg 10. In this embodiment, two restraining members 12 are respectively disposed on opposite sides of the rear leg 10. The wheel base 16 is pivotally connected to the front leg 14 and the wheel 18 is pivotally connected to the wheel base 16, such that the wheel 18 can rotate with the wheel base 16 in 360 degrees. In this embodiment, two wheel bases 16 are respectively and pivotally connected to opposite sides of the front leg 14 and two wheels 18 are respectively and pivotally connected to the two wheel bases 16. Furthermore, two wheels 20 are respectively and pivotally connected to opposite sides of the rear leg 10. Still further, the stroller 1 may further comprise a handle 22 and a pivot structure 24, wherein the handle 22 is pivotally connected to the front leg 14 by the pivot structure 24. In this embodiment, the rear leg 10 may be pivotally connected to the handle 22 or the pivot structure 24. Accordingly, the rear leg 10, the front leg 14 and the handle 22 can rotate with respect to each other to fold the stroller 1. Moreover, the stroller 1 may further comprise a connecting member 26 pivotally connected to the front leg 14 and the rear leg 10, so as to form a frame of the stroller 1 with the front leg 14, the rear leg 10 and the handle 22.

As shown in FIG. 3, the restraining member 12 comprises two restraining portions 120, wherein the two restraining portions 120 are opposite to each other, such that a restraining recess 122 is formed between the two restraining portions 120. In this embodiment, the two restraining portions 120 extend outward to form a V-shaped structure.

As shown in FIGS. 4 and 5, the front leg 14 can be folded with respect to the rear leg 10 to fold the stroller 1. When the front leg 14 is folded with respect to the rear leg 10, the wheel 18 is engaged in the restraining recess 122. Thus, when the front leg 14 is folded with respect to the rear leg 10, the restraining member 12 restrains the wheel 18 from rotating, so as to prevent the wheel 18 from deflection. Accordingly, the folded stroller 1 can stand stably and will not topple.

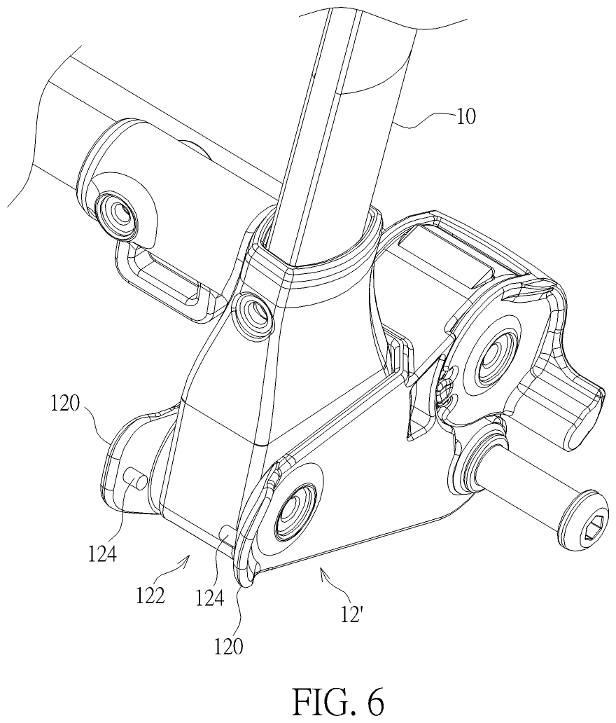

Referring to FIG. 6, FIG. 6 is an enlarged view illustrating a restraining member 12′ according to another embodiment of the invention. The main difference between the restraining member 12′ and the aforesaid restraining member 12 is that a front end of each of the two restraining portions 120 of the restraining member 12′ has a protruding portion 124, as shown in FIG. 6. The restraining member 12 shown in FIG. 4 may be replaced by the restraining member 12′ shown in FIG. 6. Thus, when the front leg 14 is folded with respect to the rear leg 10, the wheel 18 is clamped between two protruding portions 124 of the two restraining portions 120, such that the wheel 18 is engaged with the restraining member 12′ more stably. Accordingly, the folded stroller 1 can stand stably and will not topple.

As mentioned in the above, the invention disposes the restraining member on the rear leg. When the front leg is folded with respect to the rear leg, the restraining member can restrain the wheel from rotating, so as to prevent the wheel from deflection. Accordingly, the folded stroller can stand stably and will not topple.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stroller comprising:
a rear leg;
a restraining member disposed on the rear leg;
a front leg capable of being folded with respect to the rear leg;
a wheel base pivotally connected to the front leg; and
a wheel pivotally connected to the wheel base;
wherein when the front leg is folded with respect to the rear leg, the restraining member restrains the wheel from rotating.

2. The stroller of claim 1, wherein the restraining member comprises two restraining portions and the two restraining portions are opposite to each other, such that a restraining recess is formed between the two restraining portions; when the front leg is folded with respect to the rear leg, the wheel is engaged in the restraining recess.

3. The stroller of claim 2, wherein the two restraining portions extend outward to form a V-shaped structure.

4. The stroller of claim 2, wherein a front end of each of the two restraining portions has a protruding portion; when the front leg is folded with respect to the rear leg, the wheel is clamped between two protruding portions of the two restraining portions.

5. The stroller of claim 1, further comprising a handle and a pivot structure, the handle being pivotally connected to the front leg by the pivot structure.

6. The stroller of claim 1, further comprising a connecting member pivotally connected to the front leg and the rear leg.
